(19) United States
(12) Patent Application Publication
(10) Pub. No.: US 2013/0331534 A1
(43) Pub. Date: Dec. 12, 2013

(54) Polymeric superabsorbents with oligo(ethylene oxide) side chains

(71) Applicant: Timothy P. Burgin, King George, VA (US)

(72) Inventor: Timothy P. Burgin, King George, VA (US)

(73) Assignee: United States Government, as represented by the Secretary of the Navy, Arlington, VA (US)

(21) Appl. No.: 13/385,027

(22) Filed: Jan. 9, 2012

(51) Int. Cl. C08F 236/20

(52) U.S. Cl. 526/320

(57) ABSTRACT

A superabsorbent polymeric material for absorption of organic liquids which includes at least one crosslinked polymeric superabsorbent material with oligo(ethylene oxide) side chains. One such polymeric material is poly[3,6,9-trioxadecyl propenoate].

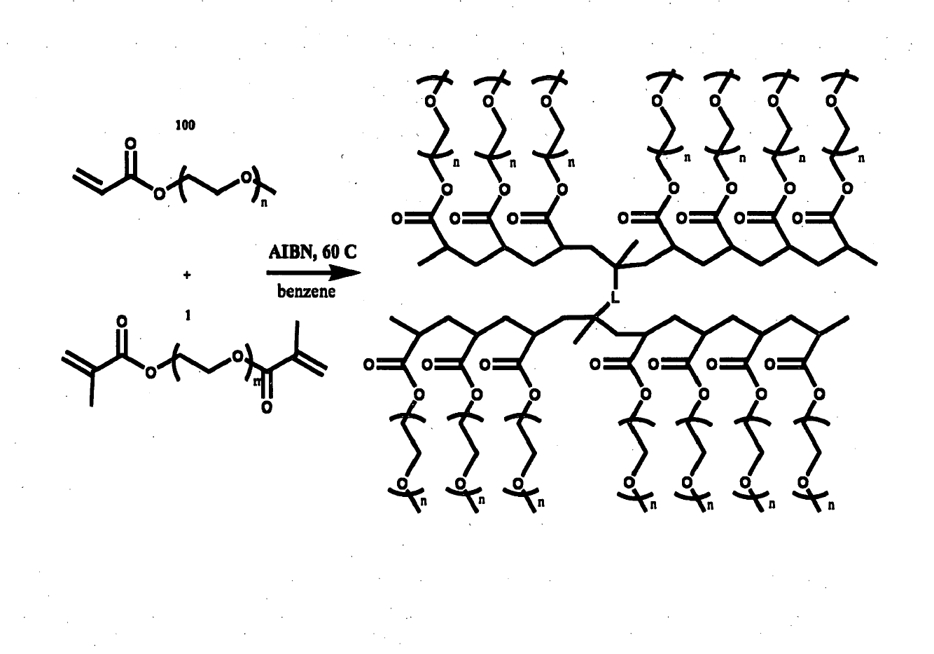

### STATEMENT OF GOVERNMENT INTEREST

The invention described was made in the performance of official duties by one or more employees of the Department of the Navy, and thus, the invention herein may be manufactured, used or licensed by or for the Government of the United States of America for governmental purposes without the payment of any royalties thereon or therefor.

### BACKGROUND

1. Technical Field

Embodiments of this disclosure relate to superabsorbents, also known as superabsorbent polymers or SAP, for the absorption of a broad spectrum of organic liquids at low percentages of absorber (5% or less). Specifically, the disclosure describes crosslinked polymeric superabsorbent material with oligo(ethylene oxide) side chains for the mitigation of hazardous organic solvents in the environment.

2. Discussion

Current commercially available sorbents may require 10% (w/w) or more of material to immobilize organic liquids. They may also have a limited range of liquids for which they are highly effective. Generally, sorbents fall into two classes, i.e., adsorbents and absorbents. Adsorbents immobilize liquids through interaction of the liquid with the surface of the material and therefore have a capacity that can be limited by the material's surface area. Absorbents may also take liquid into the internal molecular structure of the material, resulting in much higher capacity relative to adsorbents.

The balance of the interstitial solvent-material interactions and the absorption induced strain in the material determines the capacity of an absorbent material for a given solvent. The degree of swelling of a polymeric absorbent is solvent dependent, and depends on the chemical structure of the polymer backbone in addition to other factors.

Very few highly absorbent polymers for organic liquids and solvents have been identified in the literature; nearly all of them are based on alkyl acrylates. The alkyl acrylates strongly absorb some non-polar solvents but are unsuitable for solvents of higher polarity. A copolymer of alkyl acrylates with a hydrophobic trialkylammonium salt showed inverse behavior with a high absorption capacity for polar solvents and a low absorption capacity for nonpolar solvents. While the absorption capacity of the copolymer may be impressive (over a 100 times its weight for some solvents), the material suffers from a very high projected manufacturing cost. None of the known absorbents have high absorption capacities over a broad range of solvent polarities and types, i.e., alkyl, aromatic, non-polar, polar aprotic, polar protic, etc.

### SUMMARY OF THE DISCLOSURE

Accordingly, the polymers of the present disclosure have been developed as highly absorbent polymeric materials that can be manufactured at low cost, and cover a broad range of solvents.

In accordance with an embodiment of the disclosure, the superabsorbent polymeric material for absorption of organic liquids is at least one crosslinked oligo(ethylene oxide) ester polymer. In another embodiment of the disclosure, a composition includes the superabsorbent polymeric material, which may be in the form of a film, a layer, a sheet, a pad, a gel, particles, or fibers. Other embodiments of the superabsorbent polymeric material and polymer structures are provided in the detailed description.

### BRIEF DESCRIPTION OF THE DRAWINGS

These and various other features and aspects of various exemplary embodiments will be readily understood with reference to the following detailed description taken in conjunction with the accompanying drawings, in which like or similar numbers are used throughout, and in which:

The FIGURE illustrates the structure of an example of crosslinked oligo(ethylene oxide) ester polymers with high absorption capacity for organic liquids of embodiments of the present invention.

### DETAILED DESCRIPTION OF THE DISCLOSURE

A more complete appreciation of the disclosure and many of the attendant advantages will be readily obtained, as the same becomes better understood by reference to the following detailed description when considered in connection with the accompanying drawing. In describing and claiming the present invention, the following terminology will be used in accordance with the definitions set out below.

The term “polymer” is used to refer to a chemical compound that comprises linked monomers, and that may or may not be linear, crosslinked or thermosetting. The term “monomer” is used generically, unless otherwise indicated, to mean monomers, comonomers, termonomers, and tetramonomers. “Branched” polymers are understood to include hyperbranched polymers (containing two or more generations of branching), which are obtained via a polymerization reaction.

The phrases “organic solvents” and “organic liquids” are interchangeable and understood to include a chemical class of compounds that are used routinely in commercial industries. They share a common structure (at least one carbon atom and one hydrogen atom), low molecular weight, volatility, and they exist in liquid form at room temperature. They may be grouped further into aliphatic-chain compounds, and as aromatic compounds. Examples of the organic solvents include, but are not limited to, alicyclic hydrocarbons such as cyclohexane and cyclopentane, aliphatic hydrocarbons such as n-pentane, n-hexane, n-heptane and ligroin, and aromatic hydrocarbons such as benzene, toluene and xylene.

In one embodiment, this disclosure provides a new class of superabsorbent polymers for use with non-aqueous organic liquids and solvents. These superabsorbent polymers have a high absorption capacity for both polar solvents and nonpolar solvents. The superabsorbent polymers of the present disclosure are capable of absorbing and retaining amounts of organic liquids equivalent to many times their own weight. The superabsorbents polymers are crosslinked oligo(ethylene oxide) ester polymers, i.e., oligo(ethylene oxide) side chains in the polymeric structure.

In an embodiment, these polymeric materials absorb a broad spectrum of organic liquids with high efficiency, and have absorption capacities as high as 140 times their dry weight. These polymeric materials may also be relatively inexpensive to manufacture, as they can be prepared from readily available starting materials.

The FIGURE shows the general structure of the superabsorbent polymers. The illustrated general structure shows the mechanism and components for formulating the crosslinked oligo(ethylene oxide) ester polymers of the disclosure, which have a high absorption capacity for organic liquids. The number “n” of ethylene oxide groups and side chains is at least one.

In an embodiment, the polymeric material is poly[3,6,9-trioxadecyl propenoate], which absorbs organic liquids with dielectric constants between five and 40 at 20 times its weight or more. In another embodiment, the polymers can be produced from the monomers and crosslinkers by various polymerization means. For example, polymerization methods include but are not limited to bulk polymerization, belt polymerization, solution polymerization, spray polymerization, inverse emulsion polymerization and inverse suspension polymerization. The polymerization is initiated by an initiator.

All initiators forming radicals under the polymerization conditions may be used as initiators for the initiation of the polymerization, which initiators are customarily used in production superabsorbers. Other polymerization methods, such as condensation polarization, can be employed to produce similar chemical structures. In another embodiment, the superabsorbent polymeric materials of the present disclosure may be prepared by mixing the monomers in desired stoichiometric ratios in solution and then initiating free-radical copolymerization.

Crosslinking may be affected during polymerization by incorporation of suitable crosslinking monomers. Alternatively, the polymers can be crosslinked after polymerization by reaction with a suitable reactive crosslinking agent. Reaction temperature, pH, amount of added initiator, and reaction time may control the extent of crosslinking and molecular weight increase after addition of the initiator.

In another embodiment, the superabsorbent polymeric materials may be in the form of a film, a layer, a sheet, a pad, a gel, particles (granules), and fibers, and may be combined in compositions with other materials for higher absorption capacity and long-term effectiveness.

In view of the above disclosure, the polymeric materials demonstrate organic liquid absorbent capability that has several commercial applications, including chemical waste treatment, spill clean up, and solvent entrainment. In addition, these polymeric materials may significantly outperform any commercially available material at comparable cost.

Obviously, numerous modifications and variations of the disclosure are possible in light of the above disclosure. It is therefore understood that within the scope of the appended claims, the disclosure may be practiced otherwise than as specifically described herein.

1. A superabsorbent polymeric material for absorption of an organic liquid, the material consisting essentially of:
a cross-linked oligo(ethylene oxide) ester polymer having a material dry weight, the ester polymer retaining several times an absorbed dry weight of the organic liquid.

2. (canceled)

3. The superabsorbent polymeric material according to claim 1, wherein the cross-linked oligo(ethylene oxide) ester polymer has an absorption capacity of 140 times its dry weight.

4. (canceled)

5. A superabsorbent polymeric material for absorption of organic liquids consisting essentially of:
poly[3,6,9-trioxadecyl propenoate] having a material dry weight, the polymeric material retaining several times an absorbed dry weight of the organic liquid.

6. The superabsorbent polymeric material according to claim 1, wherein the organic liquids comprise polar and non-polar solvents.

7. The superabsorbent polymeric material according to claim 6, wherein the solvents comprise alicyclic organic liquids.

8. The superabsorbent polymeric material according to claim 6, wherein the solvents comprise aliphatic organic liquids.

9. The superabsorbent polymeric material according to claim 6, wherein the solvents comprise aromatic organic liquids.

10. A composition comprising the superabsorbent polymeric material according to claim 1.

11. The composition according to claim 1, wherein the composition is in the form of at least one of a film, a layer, a sheet, a pad, a gel, particles, and a plurality of fibers.

12. The superabsorbent polymeric material according to claim 1, wherein the organic liquids comprise polar and non-polar solvents.

13. The superabsorbent polymeric material according to claim 12, wherein the solvents comprise alicyclic organic liquids.

14. The superabsorbent polymeric material according to claim 12, wherein the solvents comprise aliphatic organic liquids.

15. The superabsorbent polymeric material according to claim 12, wherein the solvents comprise aromatic organic liquids.
